(19) United States
(12) Patent Application Publication
(10) Pub. No.: US 2018/0057746 A1
(43) Pub. Date: Mar. 1, 2018

(54) SELF ALIGNMENT LIQUID CRYSTAL MEDIUM COMPOSITION AND LIQUID CRYSTAL DISPLAY PANEL

(71) Applicant: Shenzhen China Star Optoelectronics Technology Co., Ltd., Shenzhen City (CN)

(72) Inventors: Song Lan, Shenzhen City (CN); Yungjui Lee, Shenzhen City (CN); Xiaolong Ma, Shenzhen City (CN)

(21) Appl. No.: 15/026,598

(22) PCT Filed: Feb. 26, 2016
(86) PCT No.: PCT/CN2016/074625

§ 371 Date: Mar. 31, 2016

(30) Foreign Application Priority Data
Feb. 1, 2016 (CN) 201610072512.8

(51) Int. Cl. C09K 19/56; G02F 1/1368; G02F 1/1335

(52) U.S. Cl. CPC C09K 19/56; G02F 1/133514; G02F 1/1368

(57) ABSTRACT

The present invention provides a self alignment liquid crystal medium composition and a liquid crystal display panel. The self alignment liquid crystal medium composition includes two or more additives, and the two or more additives are selected from a first additive and a second additive; both the molecule structures of the first additive and the second additive comprise two parts, the head group and the tail group. The main function of the head groups of the first additive and the second additive is for being anchored on the substrate with the intermolecular force, and the main function of the tail group R is similar to the function of the PI branch to vertically align the liquid crystal molecules in the steric hindrance manner. With collocation of various additives, the easily gathering property of the additive containing inorganic silicon can be improved to promote the substrate anchoring function of the additive containing organic group.

### FIELD OF THE INVENTION

The present invention relates to a display technology field, and more particularly to a self alignment liquid crystal medium composition and a liquid crystal display panel.

### BACKGROUND OF THE INVENTION

The TFT-LCD (Thin Film Transistor Liquid Crystal Display) possesses advantages of thin body, power saving and no radiation to be widely used in many application scopes. Most of the TFT-LCDs on the present market are back light type liquid crystal displays, which comprise a liquid crystal display panel and a back light module. The working principle of the liquid crystal display panel is to locate liquid crystal molecules between two parallel glass substrates. The light of back light module is reflected to generate images by applying driving voltages to control whether the liquid crystal molecules to be changed directions.

Generally, the liquid crystal display panel comprises a CF (Color Filter) substrate, a Thin Film Transistor (TFT) substrate, a LC (Liquid Crystal) sandwiched between the CF substrate and the Thin Film Transistor substrate and sealant. In the liquid crystal display panel, a layer of alignment film is further formed on the thin film transistor substrate and a color film substrate respectively. After the alignment film contacts with the LC, it can make the LC have a pre-tilted angle in certain direction, and thus provide a loading angle (the pre-tilted angle has significant influence to the driving voltage, contrast, response time and view angle of the TFT-LCD) for the liquid crystal molecules. At present, polyimide (PI) is commonly chosen to be the material of the alignment film, which mainly has rubbing alignment type IP material and lighting alignment type IP material. However, either of the alignment materials has its own drawback. The rubbing alignment type IP material is to form the alignment films by Rubbing method, and as rubbing, the issues of powder particles, residual electrostatic and brush marks reduce the process yield. The lighting alignment type IP material is to form the alignment film with photo-alignment technology. With the restriction of the material properties, the heat resistance and the aging resistance are poor, and meanwhile, the LC anchoring ability is weaker, the quality of the panel is lowered. Besides, the PI material itself has high polarity and high water absorption. The storage and the delivery can easily change the property to result in the nonuniform alignment. The price of the PI material is expensive, and the film formation process on the TFT-LCD is more complicated, which leads to the increase of the panel cost.

For solving the existing issue of the PI alignment film, a method of adding an additive in the liquid crystal material is proposed in this field, in which the additive can be vertically aligned on the substrate without the PI alignment film to act the vertical alignment function, to replace the PI alignment film. Such additive generally comprises two parts, the head group and the tail group. The main function of the head group is to utilize the intermolecular force to be anchored on the substrate, and the main function of the tail group R is similar to the function of the PI branch to vertically align the liquid crystal molecules in the steric hindrance manner.

At present, the additive mainly has two types: one is material containing inorganic group, such as octadecyltrichlorosilane, polyhedral oligomeric silsesquioxane (POSS). This kind of material has worse solubility in the liquid crystal, and will be deposited on the substrate surface for realizing the result of vertically aligning the liquid crystal. However, it is easy to unite, which can cause the poor alignment of the liquid crystal, and the dark line phenomenon happens; the other is organic material, such as octyl diphenylamine, oenanthylic acid. The drawback of this kind of material is that the anchoring function to the substrate surface is weaker, and as the concentration is lower, the light leakage phenomenon will happen to the liquid crystal.

### SUMMARY OF THE INVENTION

An objective of the present invention is to provide a self alignment liquid crystal medium composition, comprising two or more additives, and with collocation of various additives, the quality of the self alignment liquid crystal medium composition is promoted to make the additive achieve the best alignment result.

Another objective of the present invention is to provide a liquid crystal display panel, of which material of the liquid crystal layer is a self alignment liquid crystal medium composition, comprising two or more additives, and with collocation of various additives, the quality of the self alignment liquid crystal medium composition is promoted to make the additive achieve the best alignment result.

For realizing the aforesaid objectives, the present invention provides a self alignment liquid crystal medium composition, comprising liquid crystal, two or more additives mixed in the liquid crystal material;

the two or more additives are selected from a first additive and a second additive;

the first additive is a compound of which a structural formula is A-R, wherein

A is a group of containing inorganic silicon, and the group of containing inorganic silicon is —Si(CH₃)₃, —Si(OCH₃)₃, —SiCl₃ or oligomeric silsesquioxane;

R is a linear or chain branched alkyl having 3-20 C atoms, and a first group obtained after some CH₂ group in the alkyl is replaced by phenyl, cycloalkyl, —O—, —CONH—, —COO—, —O—CO—, —CO— or —CH═CH— group, a second group obtained after some H atom in the alkyl is replaced by F atom or Cl atom, or a third group obtained after some H atom in the first group is replaced by F atom or Cl atom;

the second additive is a compound of which a structural formula is C—R′, wherein

C is an organic polar group, and the organic polar group is primary amine, secondary amine, tertiary amine, —OH, —COON, —SH or —CN;

R′ is a linear or chain branched alkyl having 5-20 C atoms, and a fourth group obtained after some CH₂ group in the alkyl is replaced by phenyl, cycloalkyl, —O—, —CONH—, —COO—, —O—CO—, —CO— or —CH═CH— group, a fifth group obtained after some H atom in the alkyl is replaced by F atom or Cl atom, or a sixth group obtained after some H atom in the fourth group is replaced by F atom or Cl atom.

A structural formula of the first additive is:

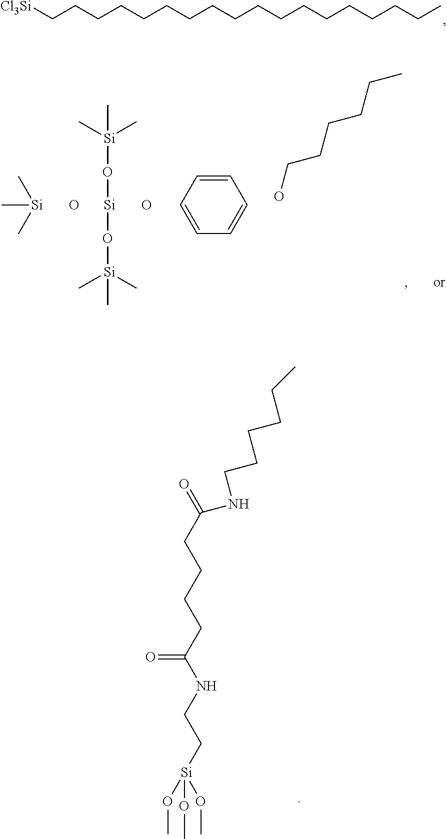

A structural formula of the second additive is:

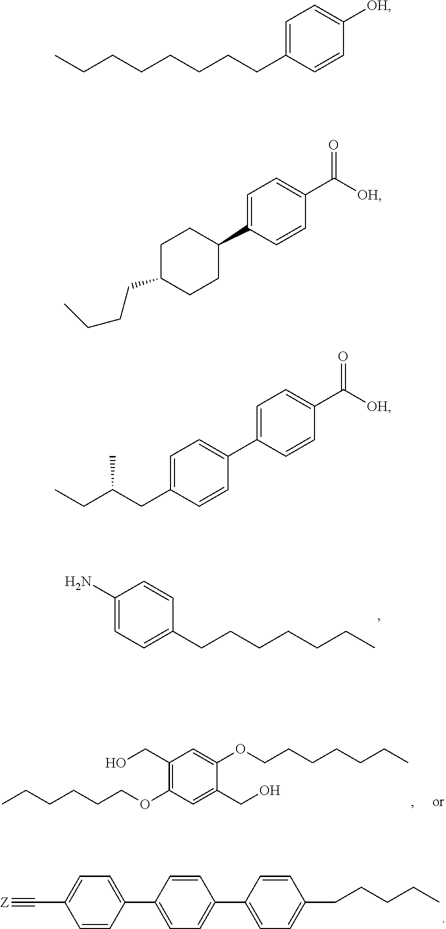

In the two or more additives, at least one is selected from the first additive, and at least one is selected from the second additive.

The two or more additives are all selected from the second additive.

A total content of the two or more additives in the self alignment liquid crystal medium composition is 0.1-5 wt %.

The composition comprises two additives, and a first kind of additive is selected from the first additive, and a second kind of additive is selected from the second additive, and a mole ratio of the first kind of additive and the second kind of additive is 1:99, and a total content of the first kind of additive and the second kind of additive in the self alignment liquid crystal medium composition is 3 wt %.

The liquid crystal material is negative type liquid crystal material.

The present invention further provides a liquid crystal display panel, comprising a TFT substrate and a CF substrate which are oppositely located, and a liquid crystal layer arranged between the TFT substrate and the CF substrate;

material of the liquid crystal layer is the aforesaid self alignment liquid crystal medium composition;

a first conductive film and a second conductive film are formed on surfaces of opposite sides of the TFT substrate and the CF substrate;

with being acted by intermolecular force, the two or more additives in the self alignment liquid crystal medium composition are vertically aligned on the surfaces of opposite sides of the TFT substrate and the CF substrate to guide liquid crystal molecules to be vertically aligned to act a function of liquid crystal alignment.

both materials of the first conductive film and the second conductive film are ITO.

The present invention further provides a self alignment liquid crystal medium composition, comprising liquid crystal, two or more additives mixed in the liquid crystal material;

the two or more additives are selected from a first additive and a second additive;

the first additive is a compound of which a structural formula is A-R, wherein

A is a group of containing inorganic silicon, and the group of containing inorganic silicon is —Si(CH₃)₃, —Si(OCH₃)₃, —SiCl₃ or oligomeric silsesquioxane;

R is a linear or chain branched alkyl having 3-20 C atoms, and a first group obtained after some CH₂ group in the alkyl is replaced by phenyl, cycloalkyl, —O—, —CONH—, —COO—, —O—CO—, —CO— or —CH═CH— group, a second group obtained after some H atom in the alkyl is replaced by F atom or Cl atom, or a third group obtained after some H atom in the first group is replaced by F atom or Cl atom;

the second additive is a compound of which a structural formula is C—R′, wherein

C is an organic polar group, and the organic polar group is primary amine, secondary amine, tertiary amine, —OH, —COOH, —SH or —CN;

R′ is a linear or chain branched alkyl having 5-20 C atoms, and a fourth group obtained after some CH₂ group in the alkyl is replaced by phenyl, cycloalkyl, —O—, —CONH—, —COO—, —O—CO—, —CO— or —CH═CH— group, a fifth group obtained after some H atom in the alkyl is replaced by F atom or Cl atom, or a sixth group obtained after some H atom in the fourth group is replaced by F atom or Cl atom;

wherein a structural formula of the first additive is:

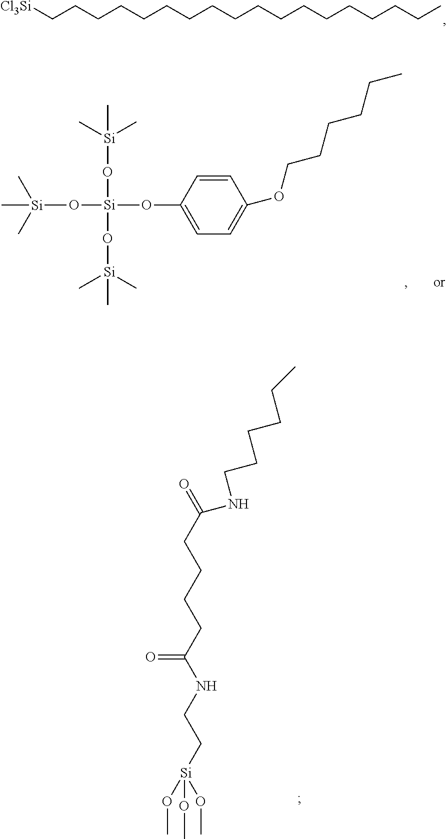

wherein a structural formula of the second additive is:

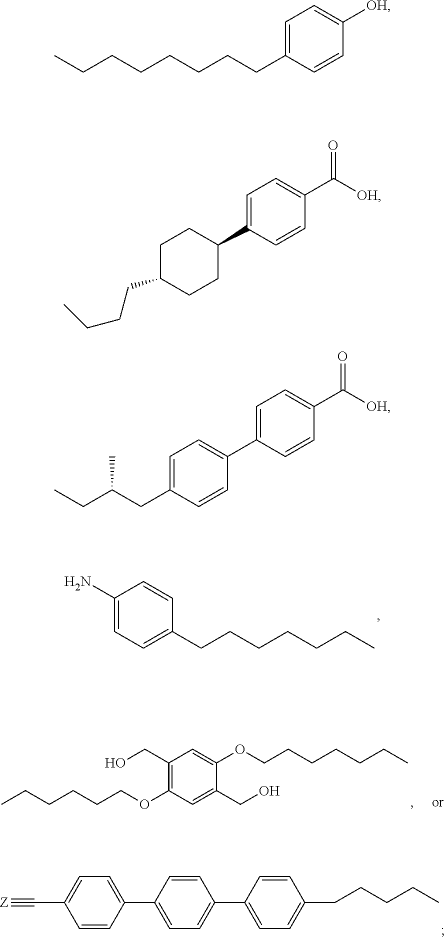

wherein the liquid crystal material is negative type liquid crystal material.

The benefits of the present invention are: the present invention provides a self alignment liquid crystal medium composition; the self alignment liquid crystal medium composition of the present invention comprises two or more additives, and the two or more additives are selected from a first additive and a second additive; both the molecule structures of the first additive and the second additive comprise two parts, the head group and the tail group. The main function of the head groups of the first additive and the second additive is for being anchored on the substrate with the intermolecular force, and the main function of the tail group R is similar to the function of the PI branch to vertically align the liquid crystal molecules in the steric hindrance manner, wherein the head group of the first additive is a group containing inorganic silicon, and the head group of the second additive is an organic group; with collocation of various additives, the easily gathering property of the additive containing inorganic silicon can be improved to promote the substrate anchoring function of the additive containing organic group, and thus to promote the quality of the self alignment liquid crystal medium composition to make the additive achieve the best alignment result. Consequently, the PI alignment film process can be eliminated to save the production cost and to decrease the energy consumption and pollution; in the liquid crystal display panel of the present invention, material of the liquid crystal layer is a self alignment liquid crystal medium composition, comprising two or more additives, and with collocation of various additives, the quality of the self alignment liquid crystal medium composition is promoted to make the additive achieve the best alignment result. Therefore, the PI alignment film is not included to save the production cost.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a structure diagram of a first additive in the self alignment liquid crystal medium composition of the present invention;

FIG. 2 is a structure diagram of a second additive in the self alignment liquid crystal medium composition of the present invention;

FIG. 3 is a structure diagram of one preferred embodiment of the liquid crystal display panel of the present invention.

### DETAILED DESCRIPTION OF PREFERRED EMBODIMENTS

For better explaining the technical solution and the effect of the present invention, the present invention will be further described in detail with the accompanying drawings and the specific embodiments.

First, the present invention provides a self alignment liquid crystal medium composition, comprising liquid crystal 53, two or more additives mixed in the liquid crystal material 53;

the two or more additives are selected from a first additive 51 and a second additive 52;

the first additive 51 is a compound of which a structural formula is A-R, wherein

A is a group of containing inorganic silicon, and the group of containing inorganic silicon is —Si(CH₃)₃, —Si(OCH₃)₃, —SiCl₃ or oligomeric silsesquioxane;

R is a linear or chain branched alkyl having 3-20 C atoms, and a first group obtained after some CH₂ group in the alkyl is replaced by phenyl, cycloalkyl, —O—, —CONH—, —COO—, —O—CO—, —CO— or —CH═CH— group, a second group obtained after some H atom in the alkyl is replaced by F atom or Cl atom, or a third group obtained after some H atom in the first group is replaced by F atom or Cl atom;

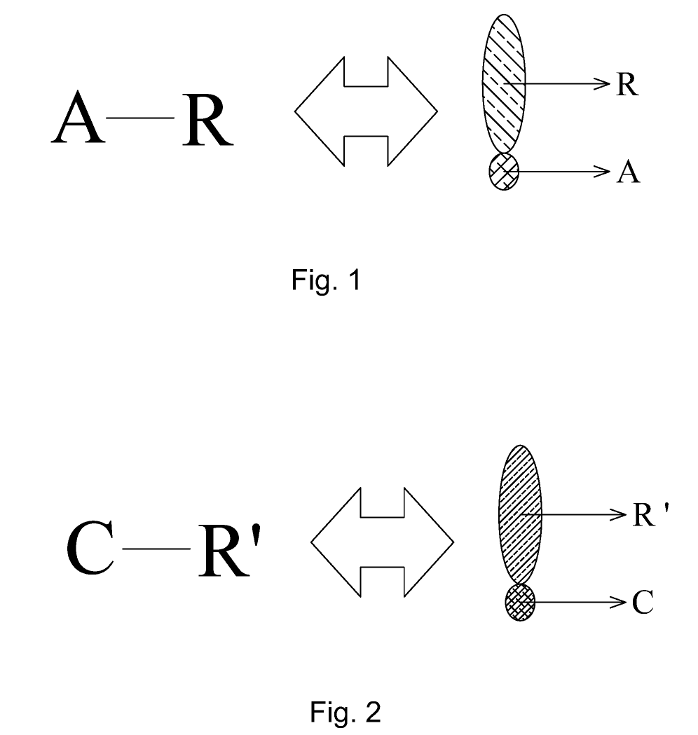

Specifically, as shown in FIG. 1, in the structural formula of the first additive 51, the head group A is a group containing inorganic silicon, of which the main function is to create the stronger intermolecular force between the first additive 51 and the substrate to be anchored on the substrate; the main function of the tail group R is similar to the function of the PI branch to vertically align the liquid crystal molecules in the steric hindrance manner.

Specifically, a structural formula of the first additive 51 is:

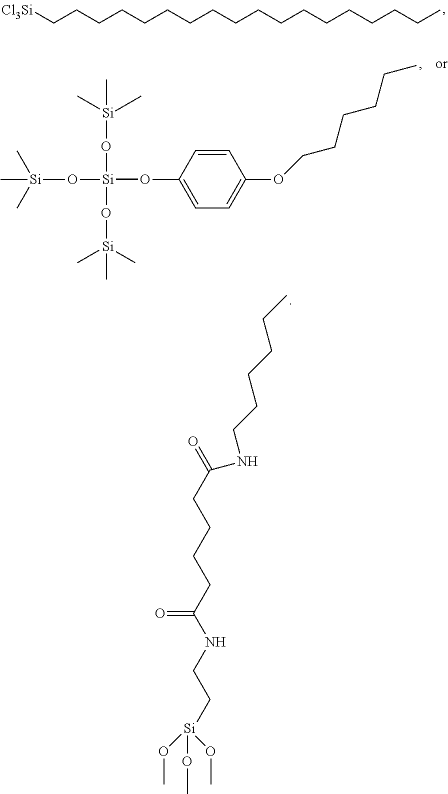

The second additive 52 is a compound of which a structural formula is C—R′, wherein

C is an organic polar group, and the organic polar group is primary amine, secondary amine, tertiary amine, —OH, —COOH, —SH or —CN;

R′ is a linear or chain branched alkyl having 5-20 C atoms, and a fourth group obtained after some CH₂ group in the alkyl is replaced by phenyl, cycloalkyl, —O—, —CONH—, —COO—, —O—CO—, —CO— or —CH═CH— group, a fifth group obtained after some H atom in the alkyl is replaced by F atom or Cl atom, or a sixth group obtained after some H atom in the fourth group is replaced by F atom or Cl atom;

Specifically, as shown in FIG. 2, in the structural formula of the second additive 52, the head group C is an organic group, of which the main function is to create the stronger intermolecular force between the second additive 52 and the substrate to be anchored on the substrate; the main function of the tail group R′ is similar to the function of the PI branch to vertically align the liquid crystal molecules in the steric hindrance manner.

Specifically, a structural formula of the second additive 52 is:

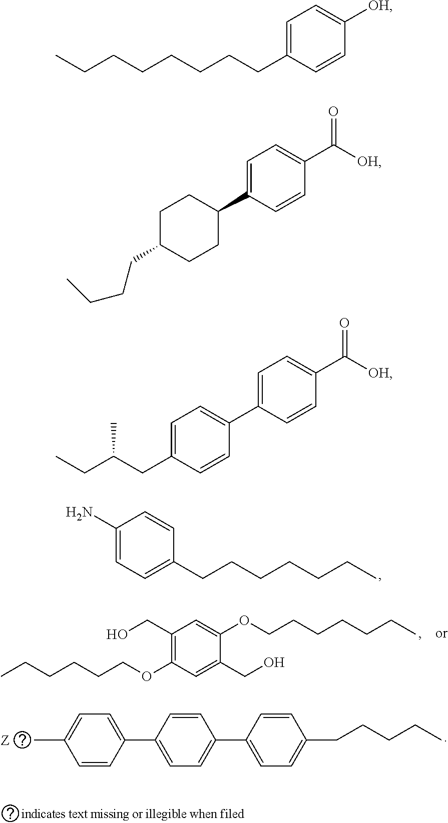

Selectably, in the two or more additives, at least one is selected from the first additive 51, and at least one is selected from the second additive 52.

Selectably, the two or more additives are all selected from the second additive 52.

Selectably, a total content of the two or more additives in the self alignment liquid crystal medium composition is 0.1-5 wt %.

Preferably, the self alignment liquid crystal medium composition comprises two additives, and a first kind of additive is selected from the first additive 51, and a second kind of additive is selected from the second additive 52, and a mole ratio of the first kind of additive and the second kind of additive is 1:99, and a total content of the first kind of additive and the second kind of additive in the self alignment liquid crystal medium composition is 3 wt %.

Specifically, the liquid crystal material 53 is negative type liquid crystal material.

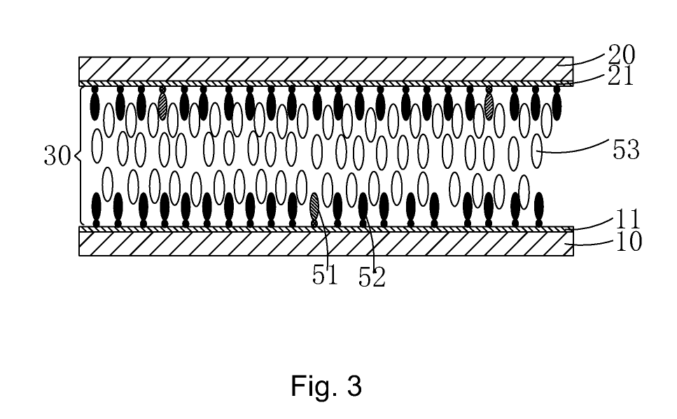

Please refer to FIG. 3. The present invention further provides a liquid crystal display panel, comprising a TFT substrate 10 and a CF substrate 20 which are oppositely located, and a liquid crystal layer 30 arranged between the TFT substrate 10 and the CF substrate 20;

material of the liquid crystal layer 30 is the aforesaid self alignment liquid crystal medium composition;

a first conductive film 11 and a second conductive film 21 are formed on surfaces of opposite sides of the TFT substrate 10 and the CF substrate 20;

with being acted by intermolecular force, the two or more additives in the self alignment liquid crystal medium composition are vertically aligned on the surfaces of opposite sides of the TFT substrate 10 and the CF substrate 20 to guide liquid crystal molecules to be vertically aligned to act a function of liquid crystal alignment.

Specifically, both materials of the first conductive film 11 and the second conductive film 21 are Indium Tin Oxide (ITO).

Preferably, the self alignment liquid crystal medium composition comprises two additives, and a first kind of additive is selected from the first additive 51, and the structural formula is:

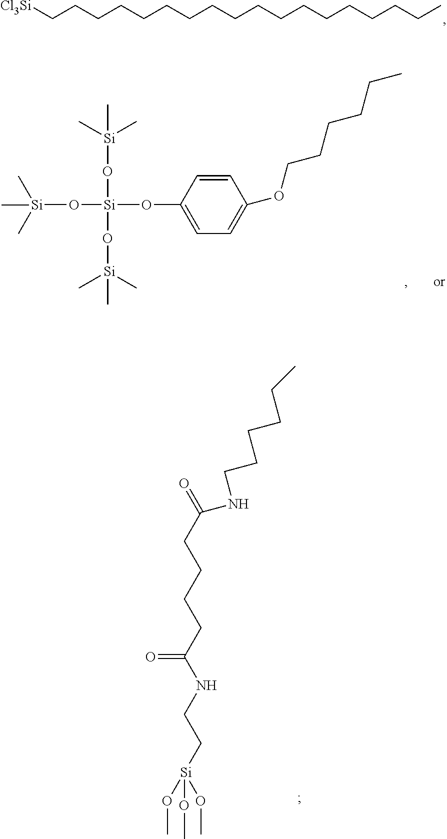

The second kind of additive is selected from the second additive 52, and the structural formula is:

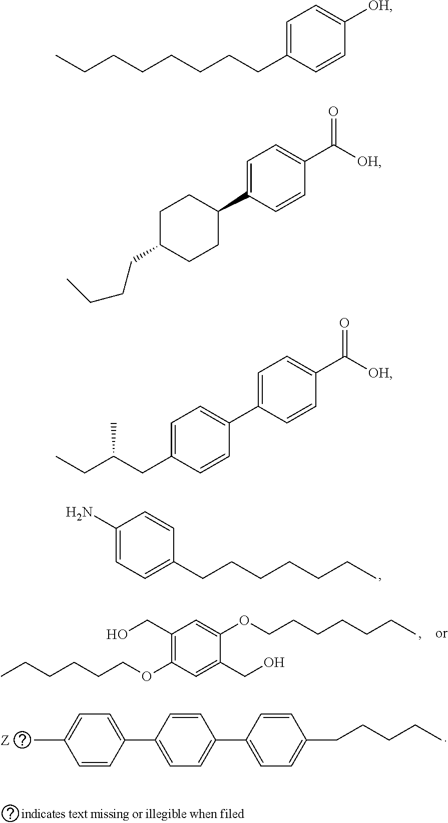

Preferably, a mole ratio of the first kind of additive and the second kind of additive is 1:99, and a total content of the first kind of additive and the second kind of additive in the self alignment liquid crystal medium composition is 3 wt %.

In conclusion, the self alignment liquid crystal medium composition of the present invention comprises two or more additives, and the two or more additives are selected from a first additive and a second additive; both the molecule structures of the first additive and the second additive comprise two parts, the head group and the tail group. The main function of the head groups of the first additive and the second additive is for being anchored on the substrate with the intermolecular force, and the main function of the tail group R is similar to the function of the PI branch to vertically align the liquid crystal molecules in the steric hindrance manner, wherein the head group of the first additive is a group containing inorganic silicon, and the head group of the second additive is an organic group; with collocation of various additives, the easily gathering property of the additive containing inorganic silicon can be improved to promote the substrate anchoring function of the additive containing organic group, and thus to promote the quality of the self alignment liquid crystal medium composition to make the additive achieve the best alignment result. Consequently, the PI alignment film process can be eliminated to save the production cost and to decrease the energy consumption and pollution; in the liquid crystal display panel of the present invention, material of the liquid crystal layer is a self alignment liquid crystal medium composition, comprising two or more additives, and with collocation of various additives, the quality of the self alignment liquid crystal medium composition is promoted to make the additive achieve the best alignment result. Therefore, the PI alignment film is not included to save the production cost.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A self alignment liquid crystal medium composition, comprising liquid crystal, two or more additives mixed in the liquid crystal material;
the two or more additives are selected from a first additive and a second additive;
the first additive is a compound of which a structural formula is A-R, wherein
A is a group of containing inorganic silicon, and the group of containing inorganic silicon is —Si(CH₃)₃, —Si(OCH₃)₃, —SiCl₃ or oligomeric silsesquioxane;
R is a linear or chain branched alkyl having 3-20 C atoms, and a first group obtained after some CH₂ group in the alkyl is replaced by phenyl, cycloalkyl, —O—, —CONH—, —COO—, —O—CO—, —CO— or —CH═CH— group, a second group obtained after some H atom in the alkyl is replaced by F atom or Cl atom, or a third group obtained after some H atom in the first group is replaced by F atom or Cl atom;
the second additive is a compound of which a structural formula is C—R′, wherein
C is an organic polar group, and the organic polar group is primary amine, secondary amine, tertiary amine, —OH, —COOH, —SH or —CN;
R′ is a linear or chain branched alkyl having 5-20 C atoms, and a fourth group obtained after some CH₂ group in the alkyl is replaced by phenyl, cycloalkyl, —O—, —CONH—, —COO—, —O—CO—, —CO— or —CH═CH— group, a fifth group obtained after some H atom in the alkyl is replaced by F atom or Cl atom, or a sixth group obtained after some H atom in the fourth group is replaced by F atom or Cl atom.

2. The self alignment liquid crystal medium composition according to claim 1, wherein a structural formula of the first additive is:

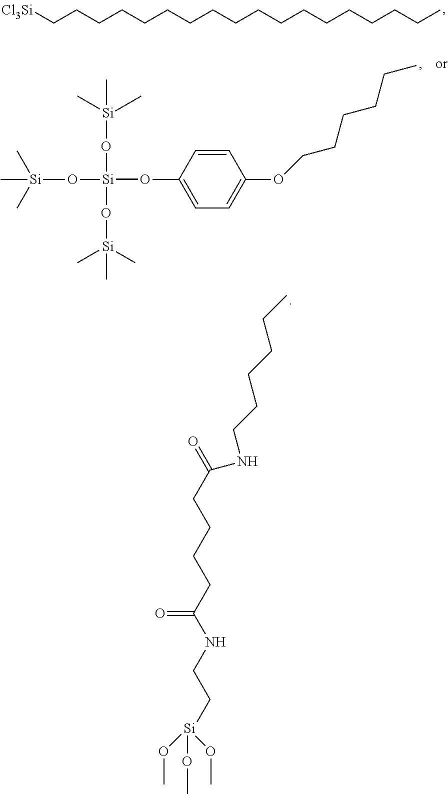

3. The self alignment liquid crystal medium composition according to claim 1, wherein a structural formula of the second additive is:

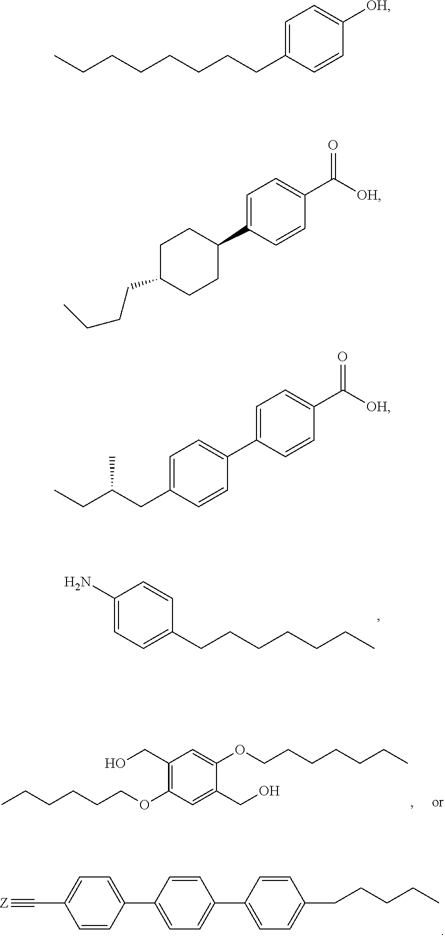

4. The self alignment liquid crystal medium composition according to claim 1, wherein in the two or more additives, at least one is selected from the first additive, and at least one is selected from the second additive.

5. The self alignment liquid crystal medium composition according to claim 1, wherein the two or more additives are all selected from the second additive.

6. The self alignment liquid crystal medium composition according to claim 1, wherein a total content of the two or more additives in the self alignment liquid crystal medium composition is 0.1-5 wt %.

7. The self alignment liquid crystal medium composition according to claim 6, wherein the composition comprises two additives, and a first kind of additive is selected from the first additive, and a second kind of additive is selected from the second additive, and a mole ratio of the first kind of additive and the second kind of additive is 1:99, and a total content of the first kind of additive and the second kind of additive in the self alignment liquid crystal medium composition is 3 wt %.

8. The self alignment liquid crystal medium composition according to claim 1, wherein the liquid crystal material is a negative type liquid crystal material.

9. A liquid crystal display panel, comprising a TFT substrate and a CF substrate which are oppositely located, and a liquid crystal layer arranged between the TFT substrate and the CF substrate;
material of the liquid crystal layer is a self alignment liquid crystal medium composition, and the self alignment liquid crystal medium composition comprises liquid crystal, two or more additives mixed in the liquid crystal material;
the two or more additives are selected from a first additive and a second additive;
the first additive is a compound of which a structural formula is A-R, wherein
A is a group of containing inorganic silicon, and the group of containing inorganic silicon is —Si(CH₃)₃, —Si(OCH₃)₃, —SiCl₃ or oligomeric silsesquioxane;
R is a linear or chain branched alkyl having 3-20 C atoms, and a first group obtained after some CH₂ group in the alkyl is replaced by phenyl, cycloalkyl, —O—, —CONH—, —COO—, —O—CO—, —CO— or —CH═CH— group, a second group obtained after some H atom in the alkyl is replaced by F atom or Cl atom, or a third group obtained after some H atom in the first group is replaced by F atom or Cl atom;
the second additive is a compound of which a structural formula is C—R′, wherein
C is an organic polar group, and the organic polar group is primary amine, secondary amine, tertiary amine, —OH, —COOH, —SH or —CN;
R′ is a linear or chain branched alkyl having 5-20 C atoms, and a fourth group obtained after some CH₂ group in the alkyl is replaced by phenyl, cycloalkyl, —O—, —CONH—, —COO—, —O—CO—, —CO— or —CH═CH— group, a fifth group obtained after some H atom in the alkyl is replaced by F atom or Cl atom, or a sixth group obtained after some H atom in the fourth group is replaced by F atom or Cl atom;
a first conductive film and a second conductive film are formed on surfaces of opposite sides of the TFT substrate and the CF substrate;
with being acted by intermolecular force, the two or more additives in the self alignment liquid crystal medium composition are vertically aligned on the surfaces of opposite sides of the TFT substrate and the CF substrate to guide liquid crystal molecules to be vertically aligned to act a function of liquid crystal alignment.

10. The liquid crystal display panel according to claim 9, wherein both materials of the first conductive film and the second conductive film are ITO.

11. A self alignment liquid crystal medium composition, comprising liquid crystal, two or more additives mixed in the liquid crystal material;
the two or more additives are selected from a first additive and a second additive;
the first additive is a compound of which a structural formula is A-R, wherein
A is a group of containing inorganic silicon, and the group of containing inorganic silicon is —Si(CH₃)₃, —Si(OCH₃)₃, —SiCl₃ or oligomeric silsesquioxane;
R is a linear or chain branched alkyl having 3-20 C atoms, and a first group obtained after some CH₂ group in the alkyl is replaced by phenyl, cycloalkyl, —O—, —CONH—, —COO—, —O—CO—, —CO— or —CH═CH— group, a second group obtained after some H atom in the alkyl is replaced by F atom or Cl atom, or a third group obtained after some H atom in the first group is replaced by F atom or Cl atom;
the second additive is a compound of which a structural formula is C—R′, wherein
C is an organic polar group, and the organic polar group is primary amine, secondary amine, tertiary amine, —OH, —COOH, —SH or —CN;
R′ is a linear or chain branched alkyl having 5-20 C atoms, and a fourth group obtained after some CH₂ group in the alkyl is replaced by phenyl, cycloalkyl, —O—, —CONH—, —COO—, —O—CO—, —CO— or —CH═CH— group, a fifth group obtained after some H atom in the alkyl is replaced by F atom or Cl atom, or a sixth group obtained after some H atom in the fourth group is replaced by F atom or Cl atom;
wherein a structural formula of the first additive is: 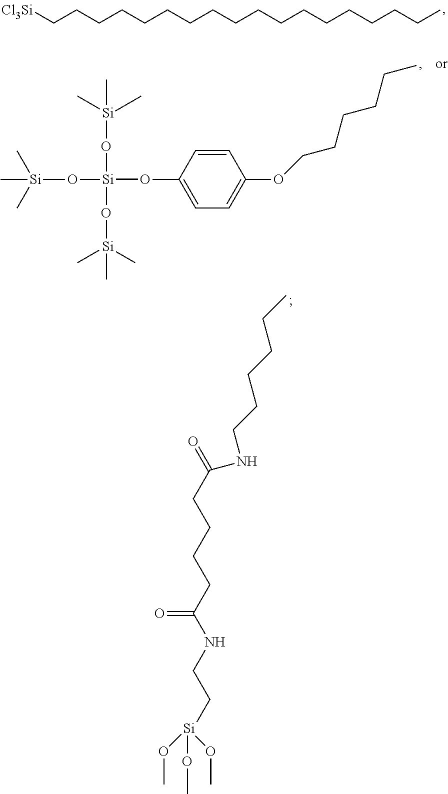
wherein a structural formula of the second additive is: 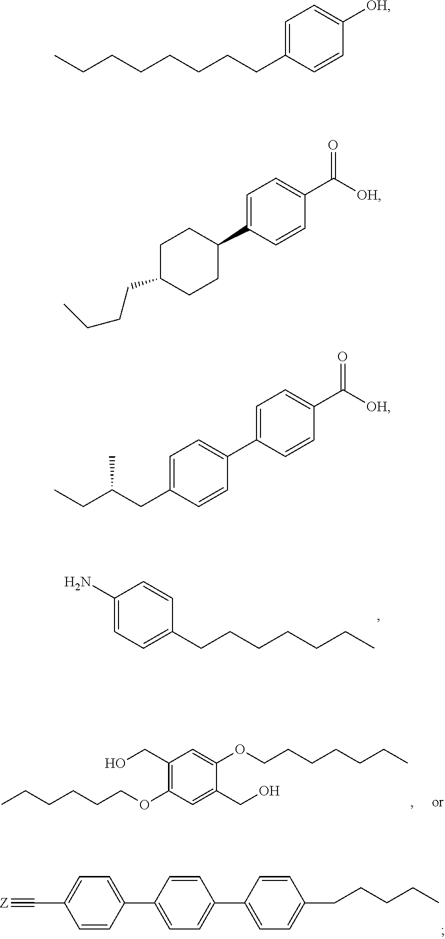
wherein the liquid crystal material is negative type liquid crystal material.

12. The self alignment liquid crystal medium composition according to claim 11, wherein in the two or more additives, at least one is selected from the first additive, and at least one is selected from the second additive.

13. The self alignment liquid crystal medium composition according to claim 11, wherein the two or more additives are all selected from the second additive.

14. The self alignment liquid crystal medium composition according to claim 11, wherein a total content of the two or more additives in the self alignment liquid crystal medium composition is 0.1-5 wt %.

15. The self alignment liquid crystal medium composition according to claim 14, wherein the composition comprises two additives, and a first kind of additive is selected from the first additive, and a second kind of additive is selected from the second additive, and a mole ratio of the first kind of additive and the second kind of additive is 1:99, and a total content of the first kind of additive and the second kind of additive in the self alignment liquid crystal medium composition is 3 wt %.
